(19) United States
(12) Patent Application Publication
(10) Pub. No.: US 2025/0310922 A1
(43) Pub. Date: Oct. 2, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Yang SHEN, Beijing (CN); Xinli WANG, Beijing (CN)

(73) Assignee: Beijing Xiaomi Mobile Software Co., Ltd., Beijing (CN)

(21) Appl. No.: 18/863,058

(22) PCT Filed: May 6, 2022
(86) PCT No.: PCT/CN2022/091317

§ 371 Date: Nov. 5, 2024

(51) Int. Cl. H04W 64/00; H04W 24/10; H04W 92/18

(52) U.S. Cl. CPC H04W 64/00; H04W 24/10; H04W 92/18

(57) ABSTRACT

Embodiments of the present disclosure provide an information processing method and apparatus, a communication device, and a storage medium. The information processing method executed by an application function (AF) may include: sending a first request message to a gateway mobile location center (GMLC), wherein the first request message comprises: identifiers of a plurality of user equipments (UEs), and requirement information of ranging and/or sidelink positioning; where the identifiers of the plurality of UEs indicate UEs that perform ranging and/or mutual positioning based on sidelink.

### CROSS-REFERENCE TO RELATED APPLICATION

The application is a U.S. National Stage of International Application No. PCT/CN2022/091317 filed on May 6, 2022, the entire content of which is incorporated herein by reference.

### TECHNICAL FIELD

The present disclosure relates to the technical field of wireless communication, but is not limited to the technical field of wireless communication, and in particular, to an information processing method and apparatus, a communication device and a storage medium.

### BACKGROUND

The distance between two or more User Equipments (UEs) and/or the direction and/or relative positioning of one terminal relative to another terminal can be determined via the PC5 interface.

Sidelink (SL) positioning refers to positioning of the terminal using PC5.

Sidelink positioning of ranging-based services includes: distance measurement, direction measurement, or distance and direction measurement.

### SUMMARY

Embodiments of the present disclosure provide an information processing method and apparatus, a communication device, and a storage medium.

A first aspect of the embodiments of the present disclosure provides an information processing method, performed by an application function (AF), the method including:
sending a first request message to a Gateway Mobile Location Center (GMLC), where the first request message includes: identifiers of a plurality of UEs, and requirement information of ranging and/or sidelink positioning;
where the identifiers of the plurality of UEs indicate UEs that perform ranging and/or mutual positioning based on sidelink.

A second aspect of the embodiments of the present disclosure provides an information processing method, performed by a GMLC, the method including:
receiving a first request message sent by an AF, where the first request message includes: identifiers of a plurality of user equipments (UEs), and requirement information of ranging and/or sidelink positioning; where the identifiers of the plurality of UEs indicate UEs that perform ranging and/or mutual positioning based on sidelink.

A third aspect of the embodiments of the present disclosure provides an information processing method, performed by an AMF, the method including:
receiving a second request message from a GMLC; where the second request message includes: identifiers of a plurality of user equipments (UEs), and requirement information of ranging and/or sidelink positioning; where the identifiers of the plurality of UEs indicate UEs that perform ranging and/or mutual positioning based on sidelink.

A fourth aspect of the embodiments of the present disclosure provides an information processing method, performed by an LMF, the method including:
receiving a third request message; where the third request message includes: identifiers of a plurality of user equipments (UEs), and requirement information of ranging and/or sidelink positioning; where the identifiers of the plurality of UEs indicate UEs that perform ranging and/or mutual positioning based on sidelink.

A fifth aspect of the embodiments of the present disclosure provides an information processing apparatus, including:
a first sending module, configured to send a first request message to a gateway mobile location center (GMLC), where the first request message includes: identifiers of a plurality of user equipments (UEs), and requirement information of ranging and/or sidelink positioning; where the identifiers of the plurality of UEs indicate UEs that perform ranging and/or mutual positioning based on sidelink.

A sixth aspect of the embodiments of the present disclosure provides an information processing apparatus, including:
a second receiving module, configured to receive a first request message sent by an AF, where the first request message includes: identifiers of a plurality of user equipments (UEs), and requirement information of ranging and/or sidelink positioning; where the identifiers of the plurality of UEs indicate UEs that perform ranging and/or mutual positioning based on sidelink.

A seventh aspect of the embodiments of the present disclosure provides an information processing apparatus, including:
a third receiving module, configured to receive a second request message from a GMLC; where the second request message includes: identifiers of a plurality of user equipments (UEs), and requirement information of ranging and/or sidelink positioning; where the identifiers of the plurality of UEs indicate UEs that perform ranging and/or mutual positioning based on sidelink.

An eighth aspect of the embodiments of the present disclosure provides an information processing apparatus, including:
a fourth receiving module, configured to receive a third request message; where the third request message includes: identifiers of a plurality of user equipments (UEs), and requirement information of ranging and/or sidelink positioning; where the identifiers of the plurality of UEs indicate UEs that perform ranging and/or mutual positioning based on sidelink.

A ninth aspect of the embodiments of the present disclosure provides a communication device, including a processor, a transceiver, a memory, and an executable program stored on the memory and capable of being run by the processor, where when the processor runs the executable program, the information processing method provided by any of the foregoing first to fourth aspects is implemented.

A tenth aspect of the embodiments of the present disclosure provides a computer storage medium, which stores an executable program; after the executable program is executed by a processor, the information processing method provided by any of the foregoing first to fourth aspects can be implemented.

The technical solutions provided by the embodiments of the present disclosure facilitate the GMLC to use one or more UEs connected to the mobile communication network in the mobile communication network to perform ranging and/or positioning services after the GMLC receives the first request message.

It should be understood that the above general description and the following detailed description are only exemplary and explanatory, and do not limit the embodiments of the present disclosure.

### BRIEF DESCRIPTION OF THE DRAWINGS

The accompanying drawings, which are incorporated in and constitute a part of this specification, illustrate the embodiments consistent with the present disclosure, and together with the specification, serve to explain the principles of the embodiments of the present disclosure.

FIG. 1 is a schematic structural diagram of a wireless communication system according to an exemplary embodiment;

FIG. 2A is a schematic diagram of a coordinate system used for ranging between UEs according to an exemplary embodiment;

FIG. 2B is a schematic diagram showing the relative position relationship between UE and network coverage according to an exemplary embodiment;

FIG. 3 is a schematic flowchart of an information processing method according to an exemplary embodiment;

FIG. 4 is a schematic flowchart of an information processing method according to an exemplary embodiment;

FIG. 5 is a schematic flowchart of an information processing method according to an exemplary embodiment;

FIG. 6 is a schematic flowchart of an information processing method according to an exemplary embodiment;

FIG. 7 is a schematic flowchart of an information processing method according to an exemplary embodiment;

FIG. 8 is a schematic flowchart of an information processing method according to an exemplary embodiment;

FIG. 9 is a schematic flowchart of an information processing method according to an exemplary embodiment;

FIG. 10 is a schematic flowchart of an information processing method according to an exemplary embodiment;

FIG. 11 is a schematic flowchart of an information processing method according to an exemplary embodiment;

FIG. 12 is a schematic flowchart of an information processing method according to an exemplary embodiment;

FIG. 13 is a schematic structural diagram of an information processing apparatus according to an exemplary embodiment;

FIG. 14 is a schematic structural diagram of an information processing apparatus according to an exemplary embodiment;

FIG. 15 is a schematic structural diagram of an information processing apparatus according to an exemplary embodiment;

FIG. 16 is a schematic structural diagram of an information processing apparatus according to an exemplary embodiment;

FIG. 17 is a schematic structural diagram of a UE according to an exemplary embodiment; and

FIG. 18 is a schematic structural diagram of a communication device according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with the embodiments of the present disclosure. Rather, they are merely examples of apparatus and methods consistent with some aspects of the embodiments of the present disclosure.

The terms used in the embodiments of the present disclosure are for the purpose of describing specific embodiments only and are not intended to limit the embodiments of the present disclosure. As used in the present disclosure, the singular forms “a/an,” “said” and “the” are intended to include the plural forms as well, unless the context clearly dictates otherwise. It should also be understood that the term “and/or” as used herein refers to and includes any or all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information, and similarly, the second information may also be called first information. Depending on the context, the word “if” as used herein may be interpreted as “when” or “upon” or “in response to determining.”

Referring to FIG. 1, a schematic structural diagram of a wireless communication system provided by an embodiment of the present disclosure is shown. As shown in FIG. 1, the wireless communication system is a communication system based on cellular mobile communication technology. The wireless communication system may include: several UEs 11 and several access devices 12.

The UE 11 may be a device that provides voice and/or data connectivity to the user. The UE 11 may communicate with one or more core networks via a Radio Access Network (RAN). The UE 11 may be an Internet of Things UE, such as a sensor device, a mobile phone (or “cellular” phone) and a computer with an Internet of Things UE. For example, it may be a fixed, portable, pocket-sized, handheld, computer-built-in or vehicle-mounted apparatus, such as a station (STA), a subscriber unit, a subscriber station, a mobile station, a mobile, a remote station, an access point, a remote UE (remote terminal), an access UE (access terminal), a user apparatus (user terminal), a user agent, a user device, or a user equipment (UE). Alternatively, the UE 11 may be a device of an unmanned aerial vehicle. Alternatively, the UE 11 may also be a vehicle-mounted device, for example, it may be an on-board computer with a wireless communication function, or a wireless communication device externally connected to an on-board computer. Alternatively, the UE 11 may also be a roadside device, for example, it may be a streetlight, a signal light or other roadside device with wireless communication function.

The access device 12 may be a network-side device in the wireless communication system. The wireless communication system may be the 4th generation mobile communication (4G) system, also known as the Long Term Evolution (LTE) system; or the wireless communication system may also be a 5G system, also called new radio (NR) system or 5G NR system. Alternatively, the wireless communication system may also be a next-generation system of the 5G system. The access network in the 5G system may be called New Generation-Radio Access Network (NG-RAN). Or, it may be an MTC system.

The access device 12 may be an evolved access device (eNB) used in the 4G system. Alternatively, the access device 12 may also be an access device (gNB) using a centralized and distributed architecture in the 5G system. When the access device 12 adopts the centralized and distributed architecture, it usually includes a central unit (CU) and at least two distributed units (DUs). The central unit is provided with protocol stacks of the Packet Data Convergence Protocol (PDCP) layer, the Radio Link Control protocol (Radio Link Control, RLC) layer, and the Media Access Control (MAC) layer; and the distributed unit is provided with a protocol stack of physical (PHY) layer, and the embodiments of the present disclosure do not limit the specific implementation of the access device 12.

A wireless connection can be established between the access device 12 and the UE 11 through a wireless air interface. In different implementations, the wireless air interface is a wireless air interface based on the fourth generation mobile communication network technology (4G) standard; or the wireless air interface is a wireless air interface based on the fifth generation mobile communication network technology (5G) standard, for example, the wireless air interface is a new air interface; alternatively, the wireless air interface may also be a wireless air interface based on the next generation mobile communication network technology standard of 5G.

The network elements or network functions involved in the embodiments of the present disclosure can be realized by an independent hardware device or by software in the hardware device, which is not limited in the embodiments of the present disclosure.

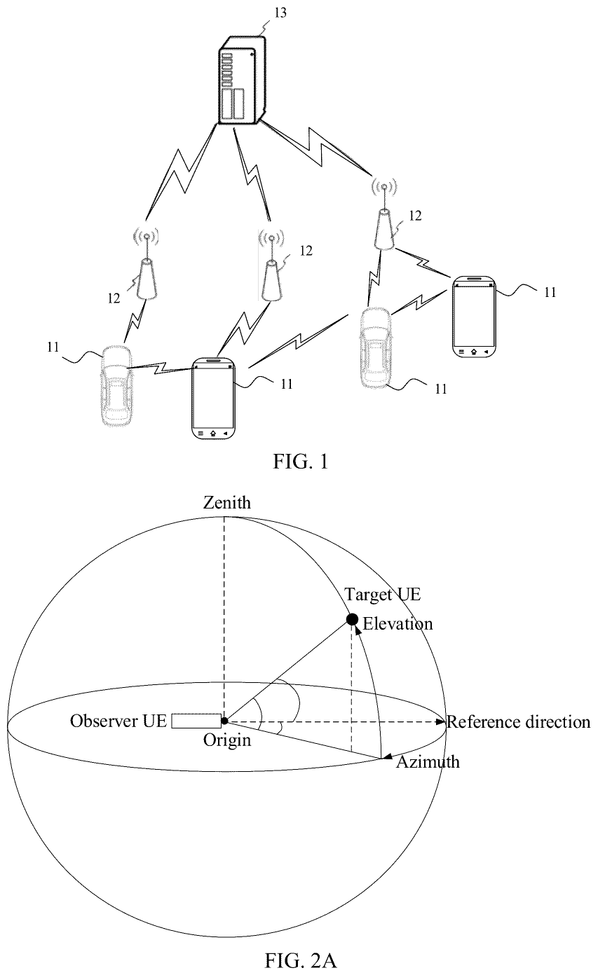

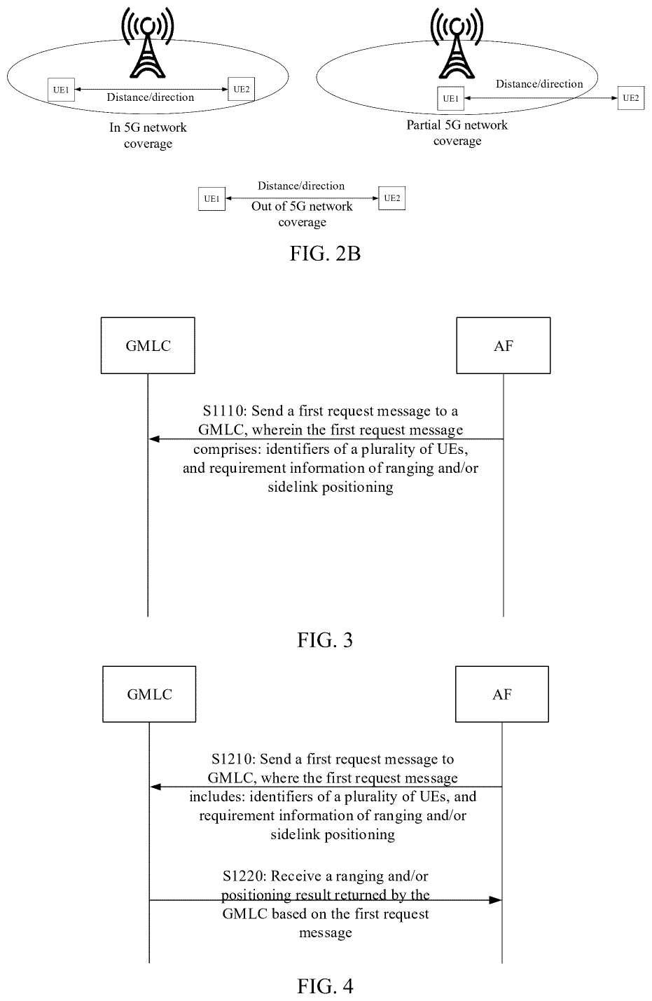

As shown in FIG. 2A, the observer UE has a reference plane and a reference direction. The direction from the target UE to the observer UE is the included angle between the line between the observer UE and the target UE and the reference direction.

This included angle is represented by the azimuth direction and the elevation direction.

The azimuth direction of the target UE is the angle formed between a reference direction and a projection direction of the connecting line between the observer UE and the target UE on the reference plane. The elevation direction of the target UE is the angle above the horizontal plane.

FIG. 2B shows the 5G network as an example, and shows the positional relationship between two UEs relative to network coverage. For example, two UEs based on SL ranging and/or positioning are both located within the 5G network coverage, two UEs are both located outside the 5G network coverage, and two UEs are partially located within the 5G network coverage.

As shown in FIG. 3, an embodiment of the present disclosure provides an information processing method, which is performed by an AF. The method includes the following steps.

In S1110: a first request message is sent to a GMLC, where the first request message includes: identifiers of a plurality of UEs, and requirement information of ranging and/or sidelink positioning;
the identifiers of the plurality of UEs indicate UEs that perform ranging and/or mutual positioning based on sidelink.

The identifiers of the plurality of UEs may include: identifiers of at least two UEs.

The plurality of UEs may include a UE that can act as an observer and/or a target UE. For example, the plurality of UEs may respectively include: at least one observer UE and at least one target UE. In some cases, the observer UE may also be called a reference UE. In all embodiments of the present disclosure, the plurality of UEs include at least one observer UE and at least one target UE, so that the ranging is performed for the target UE through the observer UE. In other embodiments of the present disclosure, details will not be described again.

In some embodiments, the identifier of the UE may include: a Globally Unique Temporary UE Identity (GUTI), a Subscriber Permanent Identifier (SUPI), a Subscriber Concealed Identifier (SUCI) and a permanent equipment identifier (PEI) of the UE.

In other embodiments, the identifier of the UE may also include: an International Mobile Equipment Identity (IMEI) or a communication identity of SL of the UE, etc.

At least two UEs whose identifiers are carried by the first request message can perform ranging and/or positioning based on the SL, so as to know the distance and/or relative position between the two UEs.

AF may be an external server of the mobile communication network and may be connected to GMLC through a Network Exposure Function (NEF).

After the GMLC receives the first request message, it is convenient for the GMLC to use one or more UEs connected to the mobile communication network in the mobile communication network to perform ranging and/or positioning services.

In some embodiments, the requirement information includes at least one of the following:
an allowed delay value of ranging/sidelink positioning;
an accuracy of ranging/sidelink positioning;
a ranging type of ranging/sidelink positioning;
a measurement parameter, including: a distance and/or a direction.

In the embodiments of the present disclosure, the ranging is also performed based on the sidelink.

For different application scenarios, SL-based ranging and/or positioning may have different allowed delay values, different required accuracy, different suitable ranging types, and/or different parameters that need to be obtained, and these can be indicated by the requirement information in the first request message.

In some embodiments, the ranging type includes one of the following:
an immediate execution type;
a deferred execution type.

The immediate execution type is: after the GMLC receives the first request message, the mobile communication network immediately starts performing SL-based ranging and/or positioning.

The deferred execution type may be: a preset type of SL-based ranging and/or positioning, therefore, after receiving the first request message, the response to the first request message may be delayed for a period of time.

The deferred execution type may also include at least one of the following:
SL-based ranging and/or positioning performed periodically;
SL-based ranging and/or positioning triggered by a trigger event.

Exemplarily, the ranging type includes one or more bits. Assuming that the ranging type includes 1 bit, then two bit values of this bit may respectively represent the immediate execution type and the deferred execution type.

For example, the ranging type may include: multiple bits; and the multiple bits may indicate a delay duration. If the values of the multiple bits are all “0”, it indicates that the ranging type is the immediate execution type; if the values of multiple bits are not “0”, it means that the ranging type is the deferred execution type, and the delay duration is equal to the delay value corresponding to the multiple bits corresponding to the ranging type. In this way, using such requirement information, multiple bits not only indicate the ranging type, but also indicate the delay duration of the ranging delay when the ranging type is a delayed ranging type.

If the first request message does not carry the allowed delay duration, a default duration and/or a duration agreed by protocol may be determined as the delay duration.

In some embodiments, if the mobile communication network is able to respond to the SL-based ranging and/or positioning requested by the first request message, the AF may receive the result of the SL-based ranging and/or positioning.

In other embodiments, if the mobile communication network does not respond to the first request message, the AF may receive a rejection message of the first request message.

The mobile communication network not responding to the first request message may include:
a service involved in the first request message or the UE using SL-based ranging and/or positioning does not have the authority to obtain SL-based ranging and/or positioning provided by the network; and/or,
when the mobile communication network cannot provide the SL-based ranging and/or positioning service requested by the requirement information, the AF may also receive a rejection message returned by the GMLC.

As shown in FIG. 4, an embodiment of the present disclosure provides an information processing method, which is executed by an AF. The method includes the following steps.

In S1210: a first request message is sent to a GMLC, where the first request message includes: identifiers of a plurality of UEs, and requirement information of ranging and/or sidelink positioning.

In S1220: a ranging and/or positioning result returned by the GMLC based on the first request message is received.

As mentioned above, the plurality of UEs include at least one observer UE and at least one target UE, so that ranging is performed for the target UE through the observer UE. In other embodiments of the present disclosure, details will not be described again.

In the embodiments of the present disclosure, if the mobile communication network connected to the GMLC determines to respond to the first request message, the corresponding UE will be scheduled to perform corresponding SL-based ranging and/or positioning, so that the AF may receive the ranging and/or positioning result returned by the GMLC.

The ranging and/or positioning result may include at least one of the following: a distance value; relative position information between the two UEs.

Referring to FIG. 2B, taking UE1 and UE2 as an example, the two UEs can perform distance measurement and/or direction measurement based on SL.

The information processing method provided by this embodiment can be executed alone or in combination with any of the aforementioned information processing methods executed by AF.

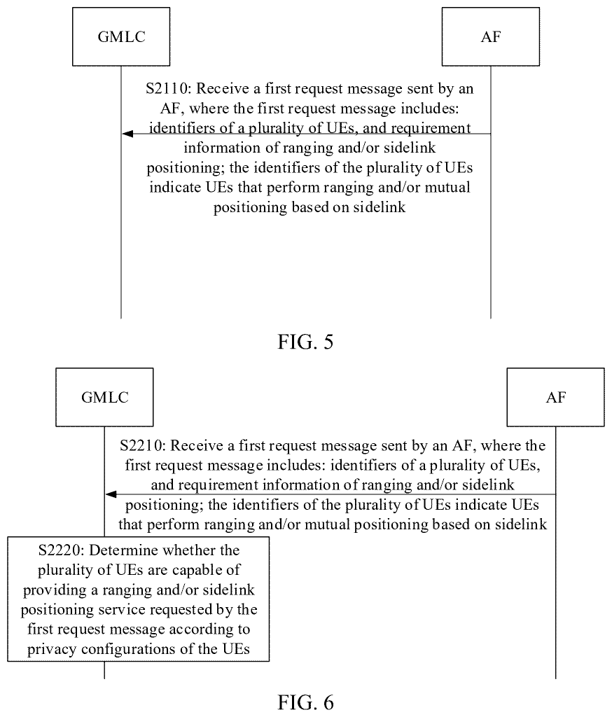

As shown in FIG. 5, an embodiment of the present disclosure provides an information processing method, which is executed by GMLC. The method includes the following steps.

In S2110: a first request message sent by an AF is received, where the first request message includes: identifiers of a plurality of UEs, and requirement information of ranging and/or sidelink positioning; the identifiers of the plurality of UEs indicate UEs that perform ranging and/or mutual positioning based on sidelink.

The GMLC may receive the first request message, which includes the identifiers of the plurality of UEs and the requirement information. After GMLC receives the first request message, it is convenient for GMLC to use one or more networks within the mobile communication network or one or more UEs connected to the mobile communication network to provide ranging and/or positioning service that meets the requirements defined by the requirement information.

As shown in FIG. 6, an embodiment of the present disclosure provides an information processing method, which is executed by a GMLC. The method includes the following steps.

In S2210: a first request message sent by an AF is received, where the first request message includes: identifiers of a plurality of UEs, and requirement information of ranging and/or sidelink positioning; the identifiers of the plurality of UEs indicate UEs that perform ranging and/or mutual positioning based on sidelink.

In S2220: whether the plurality of UEs are capable of providing a ranging and/or sidelink positioning service requested by the first request message is determined according to privacy configurations of the UEs.

The information processing method provided by this embodiment can be executed alone or in combination with any of the aforementioned information processing methods executed by the GMLC.

In some embodiments, the UE may not want to provide the SL-based ranging and/or positioning service considering its own security; or, may not have a subscription to allow other UE(s) to perform the SL-based ranging and/or positioning service on itself considering its own security. Such data can be stored in Unified Data Management (UDM) as the privacy configuration.

In some embodiments, the method further includes:
if the plurality of UEs are capable of providing the ranging and/or sidelink positioning service, determining a target AMF that participates in provision of the ranging/sidelink positioning service;
sending a second request message to the target AMF according to the first request message.

In the embodiments of the present disclosure, after receiving the first request message, a message content of the first request message is encapsulated into the second request message, or the first request message is carried as a container in the second request message to be sent to the target AMF.

In the embodiments of the present disclosure, the target AMF may be an AMF that provides the SL-based ranging and/or positioning service, usually an AMF connected to the UE identified by the identifier of the UE defined in the first request message.

In some embodiments, if the plurality of UEs are capable of providing the ranging and/or sidelink positioning service, determining the target access management function (AMF) that participates in provision of the ranging/sidelink positioning service, includes:
if the plurality of UEs are capable of providing the ranging and/or sidelink positioning service, determining AMFs connected to the plurality of UEs;
determining the target AMF from the AMFs connected to the plurality of UEs.

For example, not all of the plurality of UEs in the first request message can provide the ranging and/or sidelink positioning service. Therefore, after selecting a UE(s) that can provide the ranging and/or sidelink positioning service according to the privacy configurations, the AMF(s) connected to these UEs that can provide the ranging and/or sidelink positioning is determined as the target AMF.

For example, the GMLC may request the UDM for the address of the AMF connected to each UE one by one based on the identifier of the UE; or, it may request the UDM for the address of the AMF connected to each UE at once; it is determined whether the address of the AMF returned from the UDM is available, and if so, the AMF corresponding to the address of the AMF can be used as the target AMF.

In some embodiments, the GMLC may determine whether the address of the AMF returned from the UDM is available according to the local policy, for example, determine whether the UE connected to the AMF corresponding to each address of the AMF is located within network coverage.

If there are a plurality of available AMFs, one AMF may be randomly selected as the target AMF, or one AMF is selected as the target AMF according to the status parameter of the AMF. The status parameter includes, but is not limited to: a load rate, etc.

If there is one available AMF, the available AMF is determined as the target AMF.

The “target AMF” may be an AMF corresponding to the observer UE or an AMF corresponding to the target UE. If the target UE and the observer UE are in the same AMF, then the “AMF that performs ranging” is this AMF. In other embodiments of the present disclosure, details will not be described again.

In some embodiments, determining the AMF connected to the UE includes: selecting an AMF connected to a UE located within network coverage from the plurality of UEs as the target AMF.

Some of the UEs indicated by the identifiers of UEs carried in the first request message may be located within the network coverage, and some may be located outside the network coverage. If it is located within the network coverage, the corresponding UE can communicate with the AMF; if it is located outside the network coverage, the corresponding UE cannot communicate with the AMF. Therefore, in the embodiments of the present disclosure, the AMF connected to the UE located within the network coverage will be preferentially selected as the aforementioned target UE. In this way, the target AMF can schedule the UE located within the network coverage to start providing SL-based ranging and/or positioning services.

In some embodiments, the method further includes:
from the plurality of UEs, selecting an initiator UE that provides the ranging and/or sidelink positioning service, where the initiator UE is used to initiate a distance and/or positioning measurement between the plurality of UEs.

The initiator UE may be a UE that initiates SL-based distance and/or positioning measurement.

The initiator UE may serve as an observer UE or a target UE in SL-based ranging and/or positioning.

In one embodiment, selecting an initiator UE that provides the ranging and/or sidelink positioning service from the plurality of UEs includes:

selecting a UE that has no SL service transmission and/or New Radio (NR) transmission within the SL ranging and positioning time from the plurality of UEs as the initiator UE.

In another embodiment, the initiator UE is: a UE located within network coverage. If the initiator UE is located within network coverage, communication with the mobile communication network can be facilitated.

Exemplarily, the initiator UE may be at least one of the following:
selecting any UE located within network coverage from the plurality of UEs as the initiator UE;
selecting a UE that is located within network coverage and has the best communication quality with the network side from the plurality of UEs as the initiator UE.

The best communication quality can be reflected by the measurement value of the reference signal of the base station by the UE, or can also be reflected by the data transmission situation between the UE and the base station. For example, if the base station returns more NACKs after sending downlink data, the data transmission quality is worse; otherwise, the data transmission quality is higher. If the base station determines that more data needs to be retransmitted after receiving uplink data, it means that the data transmission quality between the UE and the base station is worse.

In some embodiments, the method further includes:
returning a ranging and/or positioning result based on the second request message;
returning the result to the AF.

After the GMLF sends the second request message to the target AMF, if the target AMF determines to respond to the second request message, the corresponding UE may be scheduled to perform the SL-based ranging and/or positioning measurement. If any UE performs the SL-based ranging and/or positioning service, the GMLC may receive the ranging and/or positioning result and return the result to the AF as the response result of the first request message.

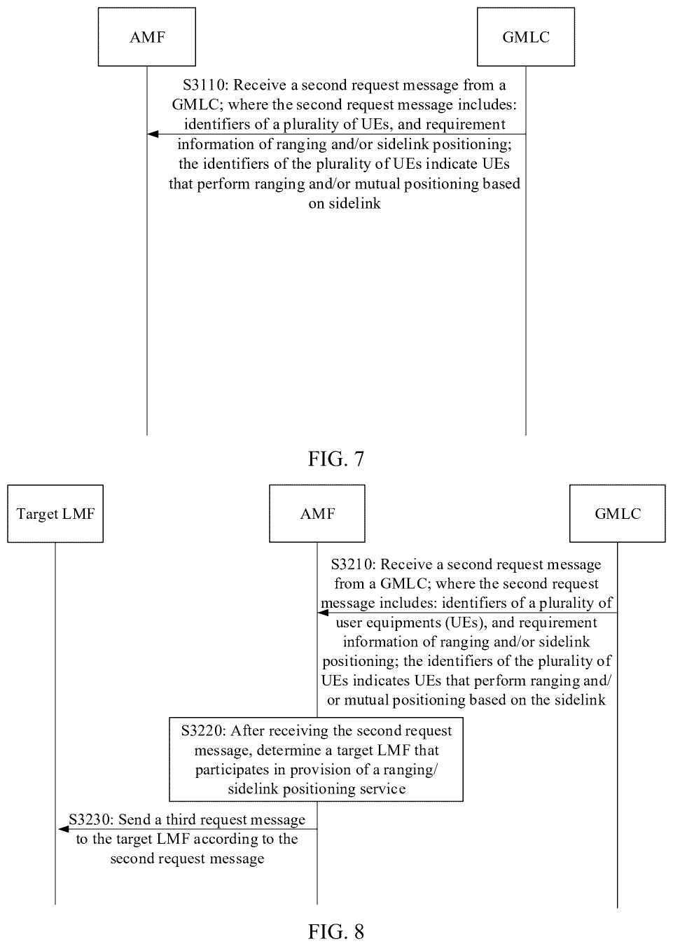

As shown in FIG. 7, an embodiment of the present disclosure provides an information processing method, which is executed by AMF. The method includes the following steps.

In S3110: a second request message from a GMLC is received; where the second request message includes: identifiers of a plurality of UEs, and requirement information of ranging and/or sidelink positioning; the identifiers of the plurality of UEs indicate UEs that perform ranging and/or mutual positioning based on sidelink.

The AMF may be a network element of the core network, connected to the GMLC, and may receive the second request message forwarded by the GMLC based on the first request message provided by the AF.

The second request message at least includes a message content of the first request message.

In some embodiments, after receiving the second request message, the AMF knows that an AF has requested SL-based ranging and/or positioning services through GMLC, and the second request message carries the requirement information of SL-based ranging and/or positioning, so that it is facilitated for the AMF to determine whether it can provide SL-based ranging and/or positioning services that meet the requirement restricted by the requirement information.

As shown in FIG. 8, an embodiment of the present disclosure provides an information processing method, which is executed by an AMF. The method includes the following steps.

In S3210: a second request message from a GMLC is received; where the second request message includes: identifiers of a plurality of user equipments (UEs), and requirement information of ranging and/or sidelink positioning; the identifiers of the plurality of UEs indicates UEs that perform ranging and/or mutual positioning based on the sidelink.

In S3220: after receiving the second request message, a target LMF that participates in provision of a ranging/sidelink positioning service is determined.

In S3230: a third request message is sent to the target LMF according to the second request message.

The LMF is a network element used to control ranging and/or positioning between the UEs and/or the base stations.

In the embodiments of the present disclosure, after receiving the second request message, the target AMF further determines the target LMF that provides the SL-based ranging and/or positioning service.

After the target LMF is determined, a third request message is sent to the target LMF.

The information processing method provided by this embodiment can be executed alone or in combination with any of the aforementioned information processing methods executed by the AMF.

In one embodiment, after receiving the second request message, determining the target location management function (LMF) that participates in provision of the ranging/sidelink positioning service includes:
after receiving the second request message, obtaining a context of the UE;
based on the context, determining the target LMF.

The LMF connected to the UE will be reflected in the context of the UE, so that the target LMF can be determined based on the context.

In another embodiment, after receiving the second request message, determining the target location management function (LMF) that participates in provision of the ranging/sidelink positioning service includes:
after receiving the second request message, selecting the target LMF according to an attribute parameter.

In one embodiment, after receiving the second request message, the LMF currently most suitable for providing the SL-based ranging and/or positioning service is directly selected according to the attribute parameter of each candidate LMF.

In some embodiments, if the context of the UE is not successfully obtained, the target LMF may be selected according to the attribute parameter of each candidate LMF.

In one embodiment, an LMF capable of providing the SL-based ranging and/or positioning service defined by the requirement information is selected according to the requirement information.

If the target LMF is selected based on the attribute parameter, the LMF whose current attribute is most consistent with providing the SL-based ranging and/or positioning service can be selected.

In some embodiments, the attribute parameter includes at least one of the following:
a quality of service (QOS) of LMF for providing the ranging/sidelink positioning service;
a type of a network accessed by LMF;
a wireless access technology used by LMF for accessing a network;
capability information of LMF;
load information of LMF;
location information of LMF.

For example, an LMF capable of providing QoS defined by the requirement information is selected as the target LMF.

For example, the type of the access network of LMF may be distinguished by different communication standards, such as 4G access network and/or 5G access network. For example, some LMFs use 5G technology to access the 5G network, and some use enhanced long-term evolution (eLTE) to access the 4G network. Considering the bandwidth differences of different access network types, an LMF with a larger access network bandwidth may be preferably selected as the target LMF.

The wireless access technology used by LMF may include: 3 Gpp access technology and/or non-3 Gpp access technology. Typical non-3 Gpp access technologies include but are not limited to: WiFi access technology.

The capability information of the LMF may reflect the ranging and/or positioning capability that the LMF can provide. In some embodiments, the LMF only supports uplink and/or downlink-based ranging and/or positioning, and does not support SL-based ranging and/or positioning. Some LMFs support uplink/downlink-based and SL-based ranging and/or positioning at the same time. In the embodiments of the present disclosure, SL-based ranging and/or positioning is adopted between UEs, and thus the target LMF supports SL-based ranging and/or positioning.

One LMF may face a plurality of base stations and/or UEs, and thus different LMFs may have different load rates at the same time. The load information includes but is not limited to: a load rate and/or a load amount.

Considering load balancing, in the case that other conditions are the same or similar, the LMF with a low load rate can be given priority as the target LMF.

In short, there are many ways to determine the target LMF, and the specific implementation is not limited to any of the above.

In some embodiments, the method further includes:
receiving a ranging and/or positioning result returned based on the third request message;
returning the ranging and/or positioning result to the GMLC.

After sending the third request message to the target LMF, the target LMF triggers SL-based ranging and/or positioning between UEs, and receives the ranging and/or positioning result from the target LMF.

As shown in FIG. 9, an embodiment of the present disclosure provides an information processing method, which is executed by LMF. The method includes the following steps.

In S4110: a third request message is received; where the third request message includes: identifiers of a plurality of user equipments (UEs), and requirement information of ranging and/or sidelink positioning; the identifiers of the plurality of UEs indicate UEs that perform ranging and/or mutual positioning based on sidelink.

The execution subject of the embodiment of the present disclosure is the LMF. The LMF may receive the third request message sent by the target AMF. The third request message includes: the identifiers of plurality of UEs that need to perform SL-based ranging and/or positioning and requirement information. In this way, the LMF can schedule the UEs to perform SL-based ranging and/or positioning according to the identifiers of the UEs.

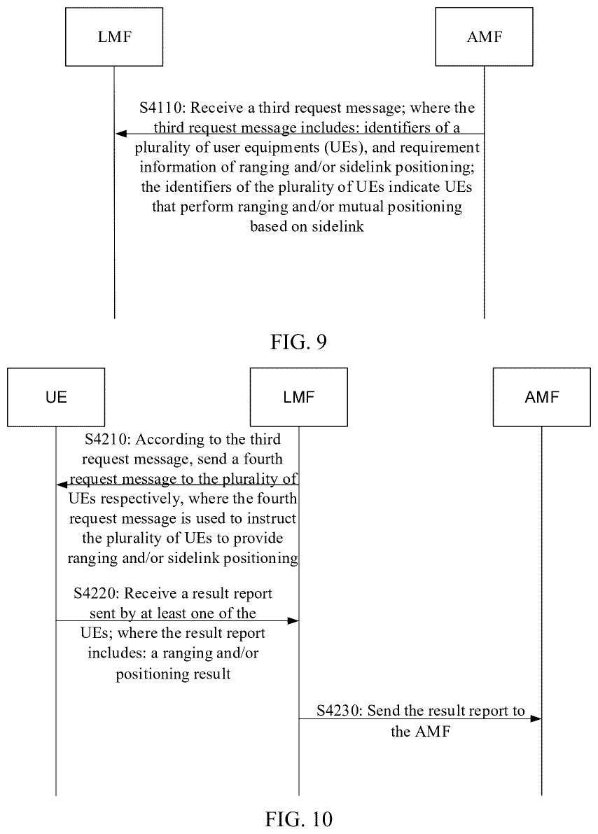

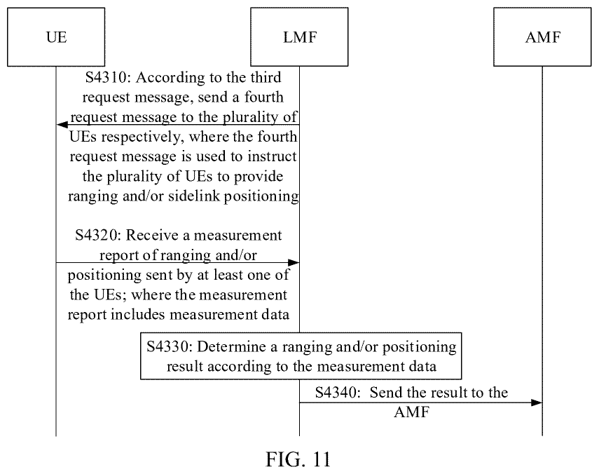

As shown in FIG. 10, an embodiment of the present disclosure provides an information processing method, which is executed by an LMF. The method includes the following steps.

In S4210: according to the third request message, a fourth request message is sent to the plurality of UEs respectively, where the fourth request message is used to instruct the plurality of UEs to provide ranging and/or sidelink positioning.

In S4220: a result report sent by at least one of the UEs is received; where the result report includes: a ranging and/or positioning result.

In S4230: the result report is sent to the AMF.

The result report includes: a ranging and/or positioning result. The ranging and/or positioning result may be generated and sent by the initiator UE.

At this time, the LMF directly receives the ranging and/or positioning result, so that the LMF does not need to calculate the ranging and/or positioning result based on the measurement result.

The information processing method provided by this embodiment can be executed alone or in combination with any of the aforementioned information processing methods executed by the LMF.

As shown in FIG. 11, an embodiment of the present disclosure provides an information processing method, which is executed by an LMF. The method includes the following steps.

In S4310: according to the third request message, a fourth request message is sent to the plurality of UEs respectively, where the fourth request message is used to instruct the plurality of UEs to provide ranging and/or sidelink positioning.

In S4320: a measurement report of ranging and/or positioning sent by at least one of the UEs is received; where the measurement report includes measurement data.

In S4330: a ranging and/or positioning result is determined according to the measurement data.

In S4340: the result is sent to the AMF.

In some embodiments, the UE that sends the result report or the measurement report is an initiator UE; the initiator UE is used to initiate distance and/or positioning measurement between the plurality of UEs. The initiator UE is a UE determined by the GMLC.

In this embodiment, the LMF receives the measurement report directly from the UE. The measurement report contains measurement data, and the LMF may need to further generate a ranging and/or positioning result based on the measurement data.

The information processing method provided by this embodiment can be executed alone or in combination with any of the aforementioned information processing methods executed by the LMF.

The measurement data includes but is not limited to: the transmitting time and receiving time of the ranging signal, the transmitting angle and/or the receiving angle of the ranging signal, and other data. When the AF wants to obtain the ranging/sidelink positioning information of the UE, the AF may send a request message to the network. The request message includes: the identifier of the UE and the requirement information of ranging/sidelink. The requirement information may include but not limited to: an allowed delay, an accuracy, and a request type.

After the GMLC receives the request, it performs privacy check; after privacy check, it queries the AMF address from UDM.

The GMLC selects one available AMF and determines the initiator UE for ranging and/or positioning.

Ranging and/or positioning are procedures that take a certain amount of time. The ranging and/or positioning procedure is performed until the ranging and/or positioning information is successfully obtained or until the allowed delay provided by AF is exceeded.

The calculation of ranging and/or positioning information may be performed by the initiator UE or LMF.

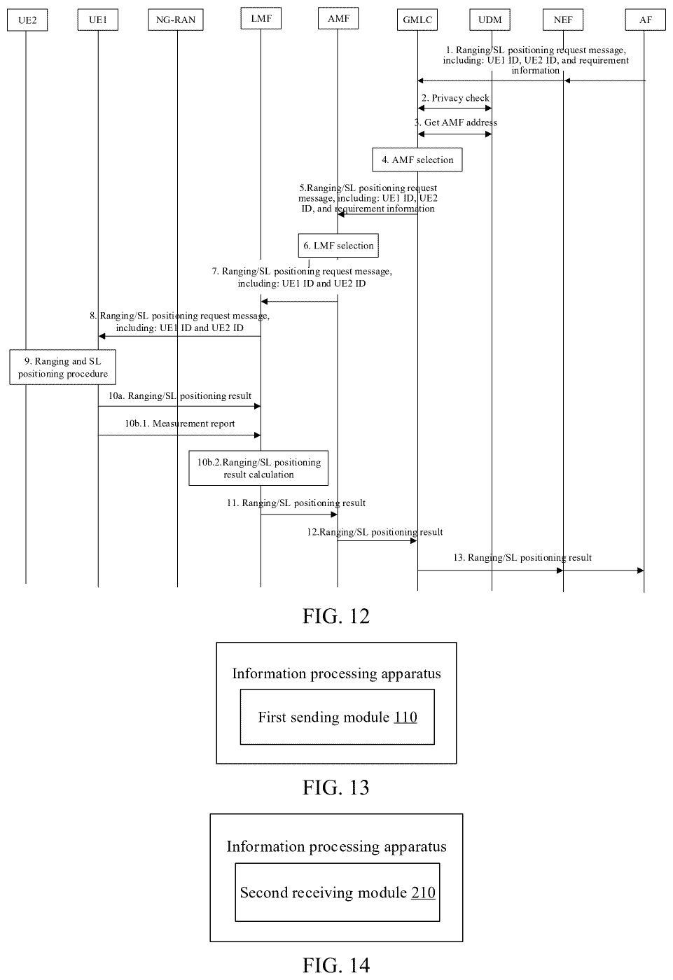

As shown in FIG. 12, an information processing method provided by an embodiment of the present disclosure may include the following steps.

1. The AF requests the ranging/sidelink positioning service, and may request the ranging/sidelink positioning information between UE1 and UE2 from GMLC. The request for ranging/sidelink positioning service may include UE1 ID and UE2 ID, and requirement information of ranging/sidelink positioning, the requirement information may include a measurement parameter (such as a distance and/or direction), an allowed delay value, an accuracy and/or ranging type (e.g. immediate or deferred).

NOTE: The AF may require ranging/sidelink positioning between two or more UEs. For example, two UEs (UE1 and UE2) are used as an example to illustrate the procedure.

2. The GMLC initiates the service operation of UEs towards the UDM to get the privacy configuration of the UEs. The UDM returns the privacy configuration of the UEs and Subscription Permanent Identifier (SUPI) of the UEs. The GMLC checks the privacy configurations of the UEs. If the UE is not allowed to perform ranging/sidelink positioning, steps 4-12 are skipped.

3. The GMLC invokes a service operation towards the UDM of the UEs that received SUPI in step 2. The UDM returns the network addresses of the currently serving AMF, or there is no AMF serving the UE. Note: The GMLC may request the AMF address of one UE at a time or both from UDM.

4. The GMLC selects one available AMF and determines the corresponding UE (e.g., UE1) as the initiator UE. Note: If the GMLC requests the AMF address of one UE at a time, the first available AMF will be selected. If the GMLC requests the AMF addresses of both UEs at a time and both AMFs are available, the GMLC will select one AMF randomly.

5. The GMLC requests the AMF to provide the ranging/sidelink positioning service.

6. The AMF selects an LMF based on the available information or local configuration in AMF

7. The AMF requests the LMF to perform ranging/sidelink positioning between UE1 and UE2.

8. The LMF triggers UE1 to perform ranging/sidelink positioning with UE2.

9. UE1 performs ranging/sidelink positioning with UE2. The NG-RAN node is involved if UE is in a network coverage state and the operator managed radio resource is used. Note: It's up to the UEs to negotiate which is the reference UE and which is the target UE.

10.

10a. UE1 reports a ranging/sidelink positioning result to LMF.

10b.1. UE1 reports the measurement value of ranging/sidelink positioning to LMF.

10b.2. The LMF calculates the ranging/sidelink positioning result based on the measurement data received from UE1.

11. The LMF returns the ranging/sidelink positioning result to the AMF.

12. The AMF forwards the ranging/sidelink positioning result to the GMLC.

13. The GMLC sends the ranging/sidelink positioning result to the AF.

In short, the ranging/sidelink positioning service request of the AF includes UE1 ID and UE2 ID, and requirement information of ranging/sidelink positioning. The requirement information indicates, but is not limited to, at least one of the following: a measurement parameter of distance and/or direction between two or more UEs, allowed delay, accuracy, and request type.

AMF selection and initiator UE determination are performed by the GMLC to select one available AMF for ranging/sidelink positioning.

The calculation of ranging/sidelink positioning result may happen in the initiator UE or in the LMF. If it occurs in the LMF, the initiator UE needs to provide a measurement report to the LMF.

As shown in FIG. 13, an embodiment of the present disclosure provides an information processing apparatus. The apparatus includes:

a first sending module 110, configured to send a first request message to a Gateway mobile location center (GMLC), where the first request message includes: identifiers of a plurality of user equipments (UEs), and requirement information of ranging and/or sidelink positioning; where the identifiers of the plurality of UEs indicate UEs that perform ranging and/or mutual positioning based on sidelink.

The information processing apparatus may be included in the AF.

In some embodiments, the first sending module 110 may be a program module; after the program module is executed by the processor, the sending of any of the aforementioned first request messages can be implemented.

In other embodiments, the first sending module 110 may include: a soft-hard combination module; the soft-hard combination module includes but is not limited to: a programmable array; the programmable array includes: a field programmable array and/or a complex programmable array.

In some embodiments, the first sending module 110 may include: a pure hardware module; the pure hardware module includes but is not limited to: an application specific integrated circuit.

In some embodiments, the information processing apparatus may include a processing module capable of generating the first request message.

In some embodiments, the requirement information includes at least one of the following:
an allowed delay value of ranging/sidelink positioning;
an accuracy of ranging/sidelink positioning;
a ranging type of ranging/sidelink positioning;
a measurement parameter, including: a distance and/or a direction.

In some embodiments, the ranging type includes one of the following:
an immediate execution type;
a deferred execution type.

In some embodiments, the apparatus further includes:
a first receiving module, configured to receive a ranging and/or positioning result returned by the GMLC based on the first request message.

As shown in FIG. 14, an embodiment of the present disclosure provides an information processing apparatus. The apparatus includes:

a second receiving module 210, configured to receive a first request message sent by an AF, where the first request message includes: identifiers of a plurality of user equipments (UEs), and requirement information of ranging and/or sidelink positioning; where the identifiers of the plurality of UEs indicate UEs that perform ranging and/or mutual positioning based on sidelink.

The information processing apparatus may be included in the GMLC.

In some embodiments, the second receiving module 210 may be a program module; after the program module is executed by the processor, the reception of any of the aforementioned first request messages can be achieved.

In other embodiments, the second receiving module 210 may include: a soft-hard combination module; the soft-hard combination module includes but is not limited to: a programmable array; the programmable array includes: a field programmable array and/or a complex programmable array.

In some embodiments, the second receiving module 210 may include: a pure hardware module; the pure hardware module includes but is not limited to: an application specific integrated circuit.

In some embodiments, the information processing apparatus may include a processing module capable of generating the first request message.

In some embodiments, the apparatus includes:

a first determination module, configured to determine whether the plurality of UEs are capable of providing a ranging and/or sidelink positioning service requested by the first request message according to privacy configurations of the UEs.

In some embodiments, the apparatus further includes:
a second determination module, configured to, if a plurality of UEs are capable of providing the ranging and/or sidelink positioning service, determine a target access management function (AMF) that participates in provision of the ranging/sidelink positioning service;
a second sending module, configured to send a second request message to the target AMF according to the first request message.

In some embodiments, the second determination module is configured to, if the plurality of UEs are capable of providing the ranging and/or sidelink positioning service, determine the AMFs connected to the plurality of UEs;
determine the target AMF from the AMFs connected to the plurality of UEs.

In some embodiments, the second determination module is configured to select an AMF connected to a UE located within network coverage from the plurality of UEs as the target AMF.

In some embodiments, the apparatus further includes:
a selection module, configured to select an initiator UE that provides the ranging and/or sidelink positioning service from the plurality of UEs, where the initiator UE is used to initiate a distance and/or positioning measurement between the plurality of UEs.

In some embodiments, the initiator UE is: a UE located within network coverage.

In some embodiments, the second receiving module 210 is configured to return a ranging and/or positioning result based on the second request message;
the apparatus further includes:
a second sending module, configured to return the result to the AF.

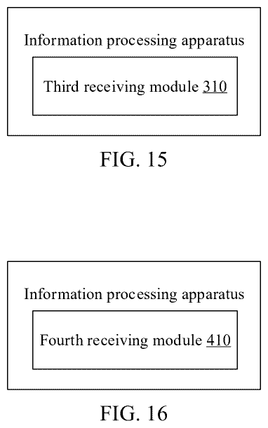

As shown in FIG. 15, an embodiment of the present disclosure provides an information processing apparatus. The apparatus includes:
a third receiving module 310, configured to receive a second request message from a GMLC;
where the second request message includes: identifiers of a plurality of user equipments (UEs), and requirement information of ranging and/or sidelink positioning; where the identifiers of the plurality of UEs indicate UEs that perform ranging and/or mutual positioning based on sidelink.

The information processing apparatus may be included in the AMF.

In some embodiments, the third receiving module 310 may be a program module; after the program module is executed by the processor, the reception of any of the aforementioned second request messages can be achieved.

In other embodiments, the third receiving module 310 may include: a soft-hard combination module; the soft-hard combination module includes but is not limited to: a programmable array; the programmable array includes: a field programmable array and/or a complex programmable array.

In some embodiments, the third receiving module 310 may include: a pure hardware module; the pure hardware module includes but is not limited to: an application specific integrated circuit.

In some embodiments, the apparatus further includes:
a third determination module, configured to, after receiving the second request message, determine a target location management function (LMF) that participates in provision of the ranging/sidelink positioning service;
a third sending module, configured to send a third request message to the target LMF according to the second request message.

In some embodiments, the third determining module is configured to obtain a context of the UE after receiving the second request message; and determine the target LMF based on the context.

In some embodiments, the third determining module is configured to select the target LMF according to an attribute parameter after receiving the second request message.

In some embodiments, the attribute parameter includes at least one of the following:
a quality of service (QOS) of LMF for providing the ranging/sidelink positioning service;
a type of a network accessed by LMF;
a wireless access technology used by LMF for accessing a network;
capability information of LMF;
load information of LMF;
location information of LMF.

In some embodiments, the third receiving module is configured to receive a ranging and/or positioning result returned based on the third request message;
the apparatus further includes:
a third sending module, configured to return the ranging and/or positioning result to the GMLC.

As shown in FIG. 16, an embodiment of the present disclosure provides an information processing apparatus. The apparatus includes:

a fourth receiving module 410, configured to receive a third request message; where the third request message includes: identifiers of a plurality of user equipments (UEs), and requirement information of ranging and/or sidelink positioning; where the identifiers of the plurality of UEs indicate UEs that perform ranging and/or mutual positioning based on sidelink.

The information processing apparatus may be included in the LMF.

In some embodiments, the fourth receiving module 410 may be a program module; after the program module is executed by the processor, the reception of any of the aforementioned third request messages can be achieved.

In other embodiments, the fourth receiving module 410 may include: a soft-hard combination module; the soft-hard combination module includes but is not limited to: a programmable array; the programmable array includes: a field programmable array and/or a complex programmable array.

In some embodiments, the fourth receiving module 410 may include: a pure hardware module; the pure hardware module includes but is not limited to: an application specific integrated circuit.

In some embodiments, the apparatus further includes:

a fourth sending module, configured to send a fourth request message to the plurality of UEs respectively according to the third request message, where the fourth request message is used to instruct the plurality of UEs to provide distance and/or sidelink positioning.

In some embodiments, the fourth receiving module 410 is further configured to receive a result report sent by at least one of the UEs; where the result report includes: a ranging and/or positioning result;
the apparatus further includes:
a fourth sending module, configured to send the result report to the AMF.

In some embodiments, the fourth receiving module 410 is further configured to receive a measurement report of ranging and/or positioning sent by at least one of the UEs; where
the measurement report includes measurement data;
the apparatus further includes:
a fourth determination module, configured to determine a ranging and/or positioning result based on the measurement data;
a fourth sending module, configured to send the result to the AMF.

In some embodiments, the UE that sends the result report or the measurement report is an initiator UE; the initiator UE is used to initiate a distance and/or positioning measurement between the plurality of UEs.

An embodiment of the present disclosure provides a communication device, including:
a memory used to store instructions executable by a processor;
the processor connecting to the memory;
where the processor is configured to execute the information processing method provided by any of the foregoing technical solutions.

The processor may include various types of storage media, which are non-transitory computer storage media that can continue to store information stored thereon after the communication device is powered off.

Here, the communication device includes: a UE or a network element, and the network element may be any one of the aforementioned GMLC to the LMF.

The processor may be connected to the memory through a bus or the like, and be used to read the executable program stored on the memory, for example, at least one of the methods shown in FIGS. 3 to 12.

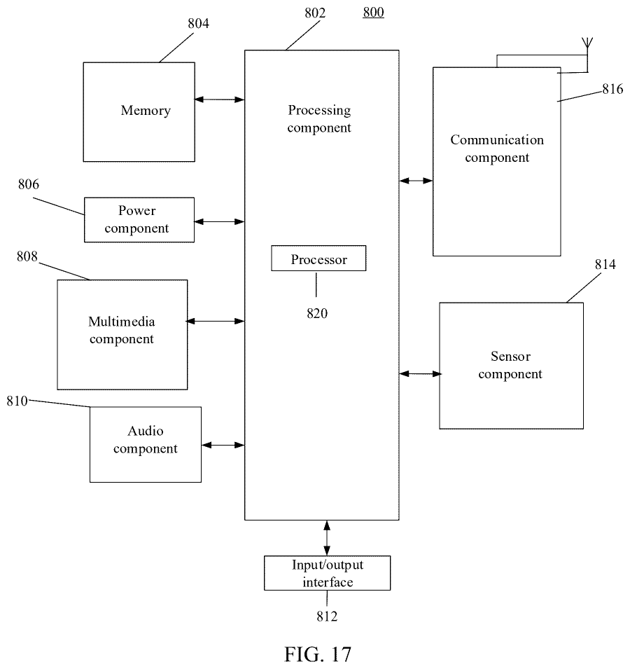

FIG. 17 is a block diagram of a UE 800 according to an exemplary embodiment. For example, the UE 800 may be a mobile phone, a computer, a digital broadcast user equipment, a messaging device, a gaming console, a tablet, a medical device, exercise equipment, a personal digital assistant, and the like.

Referring to FIG. 17, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the device 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the UE 800 and other devices. The UE 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the UE 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the UE 800, for performing the above-described methods. For example, the non-transitory computer-readable storage medium may be a ROM, a RAM, a CD-ROM, a magnetic tape, a floppy disc, an optical data storage device, and the like.

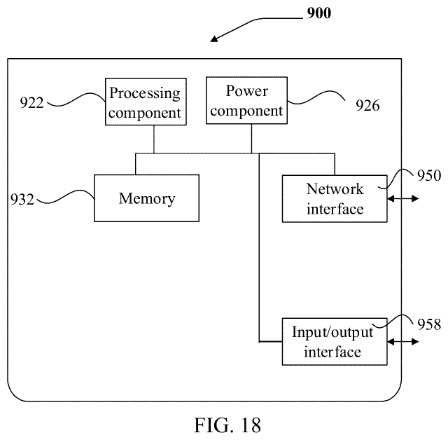

As shown in FIG. 18, an embodiment of the present disclosure illustrates a structure of a communication device. For example, the communication device 900 may be provided as a network side device. The communication device 900 may be various network elements, such as the above-mentioned access network elements and/or network functions.

Referring to FIG. 18, the communication device 900 includes a processing component 922, which further includes one or more processors, and a memory resource represented by a memory 932 for storing instructions executable by the processing component 922, such as an application program. The application program stored in the memory 932 may include one or more modules, each corresponding to a set of instructions. In addition, the processing component 922 is configured to execute instructions to perform any of the aforementioned methods executed by the access device, such as at least one of the methods as shown in FIGS. 3 to 12.

The communication device 900 may further include a power component 926 configured to perform power management of the communication device 900, a wired or wireless network interface 950 configured to connect the communication device 900 to a network, and an input/output (I/O) interface 958. The communication device 900 may operate based on an operating system stored in the memory 932, such as a Windows Server™, a Mac OS X™, a Unix™, a Linux™, a Free BSD™ or the like.

Other embodiments of the present disclosure will be apparent to those skilled in the art from consideration of the specification and practice of the contents disclosed here. The present disclosure is intended to cover any variations, uses, or adaptations of the present disclosure, which follows the general principles thereof and includes the common knowledge or habitual technical means in this technical field that is not disclosed in the present disclosure. The specification and embodiments are considered as exemplary only, with a true scope and spirit of the present disclosure being indicated by the appending claims.

It will be appreciated that the present disclosure is not limited to the exact construction that has been described above and illustrated in the accompanying drawings, and various modifications and changes can be made without departing from the scope thereof. The scope of the present disclosure is only limited by the appended claims.

1. An information processing method, performed by an application function (AF), wherein the method comprises:
sending a first request message to a gateway mobile location center (GMLC), wherein the first request message comprises: identifiers of a plurality of user equipments (UEs), and requirement information of ranging and/or sidelink positioning;
wherein the identifiers of the plurality of UEs indicate UEs that perform ranging and/or mutual positioning based on sidelink.

2. The method according to claim 1, wherein the requirement information comprises at least one of:
an allowed delay value of ranging/sidelink positioning;
an accuracy of ranging/sidelink positioning;
a ranging type of ranging/sidelink positioning;
a measurement parameter, comprising: a distance and/or a direction.

3. The method according to claim 2, wherein the ranging type comprises one of:
an immediate execution type;
a deferred execution type.

4. The method according to claim 1, further comprising:
receiving a ranging and/or positioning result returned by the GMLC based on the first request message.

5. An information processing method, performed by a GMLC, wherein the method comprises:
receiving a first request message sent by an AF, wherein the first request message comprises: identifiers of a plurality of user equipments (UEs), and requirement information of ranging and/or sidelink positioning; wherein the identifiers of the plurality of UEs indicate UEs that perform ranging and/or mutual positioning based on sidelink.

6. The method according to claim 5, wherein the method comprises:
according to privacy configurations of the UEs, determining whether the plurality of UEs are capable of providing a ranging and/or sidelink positioning service requested by the first request message.

7. The method according to claim 5, further comprising:
in response to that the plurality of UEs are capable of providing the ranging and/or sidelink positioning service, determining a target access management function (AMF) that participates in provision of a ranging/and/or sidelink positioning service;
sending a second request message to the target AMF according to the first request message.

8. The method according to claim 7, wherein in response to that the plurality of UEs are capable of providing the ranging and/or sidelink positioning service, determining the target access management function (AMF) participating in provision of the ranging and/or sidelink positioning service, comprises:
in response to that the plurality of UEs are capable of providing the ranging and/or sidelink positioning service, determining AMFs connected to the plurality of UEs;
determining the target AMF from the AMFs connected to the plurality of UEs.

9. The method according to claim 8, wherein determining the target AMFs comprises:
selecting an AMF connected to a UE located within a network coverage from the plurality of UEs as the target AMF.

10. The method according to claim 5, further comprising:
selecting an initiator UE that provides a ranging and/or sidelink positioning service from the plurality of UEs, wherein the initiator UE is configured to initiate a distance and/or positioning measurement between the plurality of UEs.

11. The method according to claim 10, wherein the initiator UE is: a UE located within a network coverage.

12. The method according to claim 7, further comprising:
returning a ranging and/or positioning result based on the second request message;
returning the result to an AF.

13.-18. (canceled)

19. An information processing method, performed by an LMF, wherein the method comprises:
receiving a third request message; wherein the third request message comprises:
identifiers of a plurality of user equipments (UEs), and requirement information of ranging and/or sidelink positioning; wherein the identifiers of the plurality of UEs indicate UEs that perform ranging and/or mutual positioning based on sidelink.

20. The method according to claim 19, further comprising:
sending a fourth request message to the plurality of UEs respectively according to the third request message, wherein the fourth request message is configured to instruct the plurality of UEs to provide ranging and/or sidelink positioning.

21. The method according to claim 19, further comprising:
receiving a result report sent by at least one of the UEs; wherein the result report comprises: a ranging and/or positioning result;
sending the result report to an AMF.

22. The method according to claim 19, further comprising:
receiving a measurement report of ranging and/or positioning sent by at least one of the UEs; wherein the measurement report comprises measurement data;
determining a ranging and/or positioning result based on the measurement data;
sending the result to the AMF.

23. The method according to claim 21, wherein a UE that sends the result report or the measurement report is an initiator UE; and the initiator UE is configured to initiate a distance and/or positioning measurement between the plurality of UEs.

24.-46. (canceled)

47. A communication device, comprising a processor, a transceiver, a memory, and an executable program stored in the memory and capable of being run by the processor, wherein when the processor runs the executable program, the method according to claim 1 is executed.

48. (canceled)

49. A communication device, comprising a processor, a transceiver, a memory, and an executable program stored in the memory and capable of being run by the processor, wherein when the processor runs the executable program, the method according to claim 5 is executed.

50. A communication device, comprising a processor, a transceiver, a memory, and an executable program stored in the memory and capable of being run by the processor, wherein when the processor runs the executable program, the method according to claim 19 is executed.
